(19) United States
(12) Patent Application Publication
(10) Pub. No.: US 2008/0189040 A1
(43) Pub. Date: Aug. 7, 2008

(54) Collision Avoidance System

(75) Inventors: Shingo Nasu, Hitachinaka (JP); Masaru Yamasaki, Kasumigaura (JP); Masanori Ichinose, Tsukuba (JP); Tatsuya Yoshida, Naka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 11/950,958

(22) Filed: Dec. 5, 2007

(30) Foreign Application Priority Data
Feb. 1, 2007 (JP) 2007-023355

(51) Int. Cl. B60W 30/08; B60W 40/06

(52) U.S. Cl. 701/301

(57) ABSTRACT

According to the present invention, an obstacle detection means detects an obstacle. An action range presumption unit presumes an action range in which the obstacle can exist in a predetermined time if the obstacle accelerates, decelerates, or turns on the basis of the moving performance of the obstacle detected by the obstacle detection means. An action probability presumption unit presumes a probability of the obstacle existing in the action range on the basis of the conditions of the road on which a host vehicle and the obstacle exist and the action history of the obstacle. A driving operation support unit determines a target locus which prevents the host vehicle from moving into the presumed action range or to a position where the action probability is high and generates vehicle control information necessary for making the host vehicle run along the target locus. The driving operation support unit gives the driver instructions and warnings and assists the driver with driving operation support operations. Thus, the possibility of collision of the host vehicle with the obstacle can be reduced even if the obstacle makes an action beyond the scope of the driver's assumption.

### BACKGROUND OF THE INVENTION

1. Field of the Invention

The present invention relates to a collision avoidance system for preventing a vehicle from collision and, more particularly, to a collision avoidance system enabling the collision avoidance of a vehicle with an obstacle detected by a sensor attached to the vehicle by assisting with driver's driving operations or by controlling the vehicle by automatic driving operations.

2. Description of the Related Art

A conventional collision avoidance system enables the collision of a vehicle with an obstacle detected by a sensor by, for example, a driving operation support method that presumes time in which the vehicle will collide with the obstacle detected by the sensor on the basis of the position and velocity of the vehicle relative to the obstacle, and controls the steering angle and velocity of the vehicle. An obstacle detection method disclosed in JP-A-2004-110394 decides whether or not an obstacle detected by a camera or a radar is dangerous, and decides, when the obstacle is on a possible locus presumed on the basis of the condition of a road on which the vehicle is running at the present and the steering angle of the vehicle, that the vehicle is in a more serious danger as compared with a state where any obstacle is not on the presumed locus.

### SUMMARY OF THE INVENTION

This known obstacle detection method is based on the assumption that the obstacle continues the present action being performed at the time of detection of the obstacle. If the action of the obstacle changes beyond this scope of the assumption, the degree of danger to the vehicle changes greatly, and the vehicle may possibly collide with the obstacle if things comes to the worst.

The present invention has been made in view of such problems, and it is therefore an object of the present invention to provide a collision avoidance system capable of presuming an action range in which an obstacle can exist when the obstacle accelerates, decelerates and/or turns after being detected on the basis of the moving performance of the obstacle presumed by an obstacle detection means; of estimating a probability of the obstacle existing in the action range on the basis of the environmental condition and action history of the obstacle; and of carrying out driving operation support operations to prevent the vehicle from moving into an action range in which the obstacle can exist or an action range into which a probability of the obstacle moving is high.

According to one aspect of the present invention, there is provided a collision avoidance system including: obstacle detection means for detecting obstacles existing around a host vehicle; an action range presumption means for presuming an action range in which an obstacle can exist at time a predetermined time after being detected on the basis of the moving performance of the obstacle detected by the obstacle detection means; an action probability presumption means for estimating an action probability of the obstacle existing in the action range presumed by the action range presumption means; and a driving operation support means for determining driving operation support operations on the basis of the action range presumed by the action range presumption means and the action probability presumed by the action probability presumption means and executing the driving operation support operations.

Preferably, the collision avoidance system of the present invention presumes the action range in which the obstacle can exist at time a predetermined time after being detected on the basis of the moving performance of the obstacle detected by the obstacle detection means, presumes an action probability of the obstacle existing in the action range presumed by the action range presumption means, determines the driving operation support operations on the basis of the action range presumed by the action range presumption means and the action probability presumed by the action probability presumption means and executes the driving operation support operations. Thus, the collision avoidance system can carry out the driving operation support operations to ensure collision avoidance with reliability.

In the collision avoidance system according to the present invention, preferably, the action range presumption means further presumes an action range in which the host vehicle can exist in a predetermined time, and the action probability presumption means further presumes an action probability of the host vehicle existing in the action range. Thus, the driving operation support operations are determined and executed after the action range is presumed in which the host vehicle can exist in a predetermined time. Therefore, the collision avoidance system can carry out the driving operation support operations to ensure collision avoidance with reliability.

The collision avoidance system according to the present invention may preferably include an obstacle characteristics detection means, wherein the action range presumption means presumes the action range, and the action probability presumption means presumes the action probability on the basis of the moving performance specific to the type of the obstacle determined by the obstacle characteristics detection means. For example, suppose that a track is running ahead of the host vehicle. In that case, the obstacle characteristics detection means determines that the obstacle is a truck, presumes the action range, and presumes the action probability on the basis of the moving performance specific to the truck. Thus the presumed action range and the presumed action probability can be determined with high reliability and reliable driving operation support can be achieved to ensure safer collision avoidance.

In the collision avoidance system according to the present invention, preferably, the action range presumption means and the action probability presumption means detect the condition of the road on which at least either of the host vehicle and the obstacle is running. The action range presumption means changes the presumed action range according to the detected condition of the road, and the action probability presumption means also changes the presumed action probability according to the detected condition of the road. Thus, the collision avoidance system determines conditions of the road including the coefficient of friction on the road and the inclination of the road and adjusts the action range for the obstacle and the action probability of the obstacle according to the conditions of the road. For example, if the road is icy or slopes down, the collision avoidance system presumes the action range for the obstacle and presumes the action probability of the obstacle existing in the action range taking the condition of the road into consideration. Thus, driving operation support operations determined according to the condition of the road can be carried out so as to ensure reliable collision avoidance.

The collision avoidance system according to the present invention may preferably include an action history storage means for storing the action history of the obstacle, wherein the action probability presumption means presumes the action probability of the obstacle existing in the action range presumed by the action range presumption means taking into consideration the action history of the obstacle stored in the action history storage means.

According to the present invention, preferably, the action probability of the obstacle existing in the action range presumed by the action range presumption means is presumed based on the action history of the obstacle. For example, if the obstacle has a tendency to change traffic lanes frequently, the action probability of the obstacle moving into the particular traffic lane is presumed to be high to determine and execute the driving operation support operations. Thus, the driving operation support operations further improve the reliability of collision avoidance.

The collision avoidance system according to the present invention may preferably include an external communication means capable of communicating with an external system, wherein the action range presumption means presumes a range in which the obstacle can exist taking into consideration the information about the action of the obstacle acquired through the external communication means, and the action probability presumption means presumes an action probability of the obstacle existing in the action range. According to the present invention, the information about the action and such of the obstacle can be obtained through inter-vehicle communication or vehicle-roadside communication by the external communication means. Therefore, the presumption of the action range by the action range presumption means and the estimation of the action probability by the action probability presumption means can be achieved with reliability. Thus, the driving operation support operations can ensure more reliable collision avoidance.

In the collision avoidance system according to the present invention, preferably, when the obstacle changes traffic lanes, the action probability presumption means presumes a higher probability of the obstacle moving in the direction in which the traffic lane is changed as compared with a probability of the obstacle existing in the action range when the obstacle does not need to change traffic lanes.

In the collision avoidance system according to the present invention, preferably, when the obstacle is stationary and cannot readily move, the action range presumption means presumes a range in which the obstacle can exist to be greater than the size of the obstacle. The collision avoidance system of the present invention can thus carry out driving operation support operations such that the distance between the vehicle and the obstacle is sufficient enough to achieve safer collision avoidance.

In the collision avoidance system according to the present invention, preferably, the action range presumption means increases the presumed range in which the obstacle can exist as the running speed of the vehicle increases. Thus, in the present invention, the presumed range in which the obstacle can exist is increased with the increase of the running speed of the vehicle to carry out driving operation support operations so that the vehicle can avoid the obstacle securing a wide space between the vehicle and the obstacle when the vehicle is running at a high running speed. Therefore, the driver will not be seized with fear.

In the collision avoidance system according to the present invention, preferably, when a turn-signal lamp of the obstacle is turned on, the action probability presumption means presumes a higher probability of the obstacle moving in the direction indicated by the turn-signal lamp than a probability of a case where any turn signal lamp is not turned on.

In the collision avoidance system according to the present invention, preferably, the driving operation support means assists with a driving operation to avoid the vehicle moving into the action range presumed by the action range presumption means.

In the collision avoidance system according to the present invention, preferably, when the vehicle unavoidably advances into an action range presumed by the action range presumption means in which the obstacle is expected to exist in a predetermined time, the driving operation support means carries out driving operation support operations so that the vehicle moves in a direction in which the action probability presumed by the action probability presumption means is low.

The collision avoidance system according to the present invention is mounted on an automobile.

In the collision avoidance system according to the present invention, the obstacle detection means obtains the information about the size, moving speed and position of an obstacle when the vehicle encounters the obstacle during running; the action range presumption means presumes the action range in which the obstacle can exist in a predetermined time on the basis of the information provided by the obstacle detection means; the action probability presumption means presumes a probability of the obstacle existing in the presumed action range; and the driving operation support means determines and carries out driving operation support operations based on the presumed action range and action probability in order to prevent the vehicle from entering the action range of the obstacle or a place in which an action probability of the obstacle existing is high. Thus, even if the obstacle accelerates, decelerates and/or turns, which is beyond the scope of the driver's assumption, the vehicle runs through a space outside the range in which the obstacle can exist or a space in which a probability of the obstacle existing is low. Consequently, the possibility of the collision between the vehicle and the obstacle can be reduced.

### BRIEF DESCRIPTION OF THE DRAWINGS

FIG. 1 is a bock diagram of a collision avoidance system;

FIG. 2 is a flow chart of a control procedure to be carried out by the collision avoidance system;

FIG. 3 is a pictorial view of assistance in explaining control operations to be carried out by the collision avoidance system from the detection of an obstacle to the start of driving operation support operations;

FIG. 4 is a pictorial view of assistance in explaining an action range presumption procedure to be carried out when the collision avoidance system detects a stationary obstacle;

FIG. 5 is a flow chart of a control procedure to be carried out by the collision avoidance system when the collision avoidance system detects a stationary obstacle;

FIG. 6 is a pictorial view of assistance in explaining operations for estimating an action probability and presuming an action range when the collision avoidance system detects an obstacle about to overtake a host vehicle;

FIG. 7 is a pictorial view of assistance in explaining estimating an action probability and presuming an action range when a turn signal lamp of an obstacle ahead of a host vehicle is turned on;

FIG. 8 is a flow chart of a control procedure to be carried out by the collision avoidance system when the collision avoidance system detects an obstacle about to overtake a host vehicle as shown in FIG. 6; and

FIG. 9 is a pictorial view of assistance in explaining a control procedure to be carried out by the collision avoidance system when a host vehicle overtakes two obstacles on the right and the left side, respectively, of the host vehicle.

### DESCRIPTION OF THE PREFERRED EMBODIMENTS

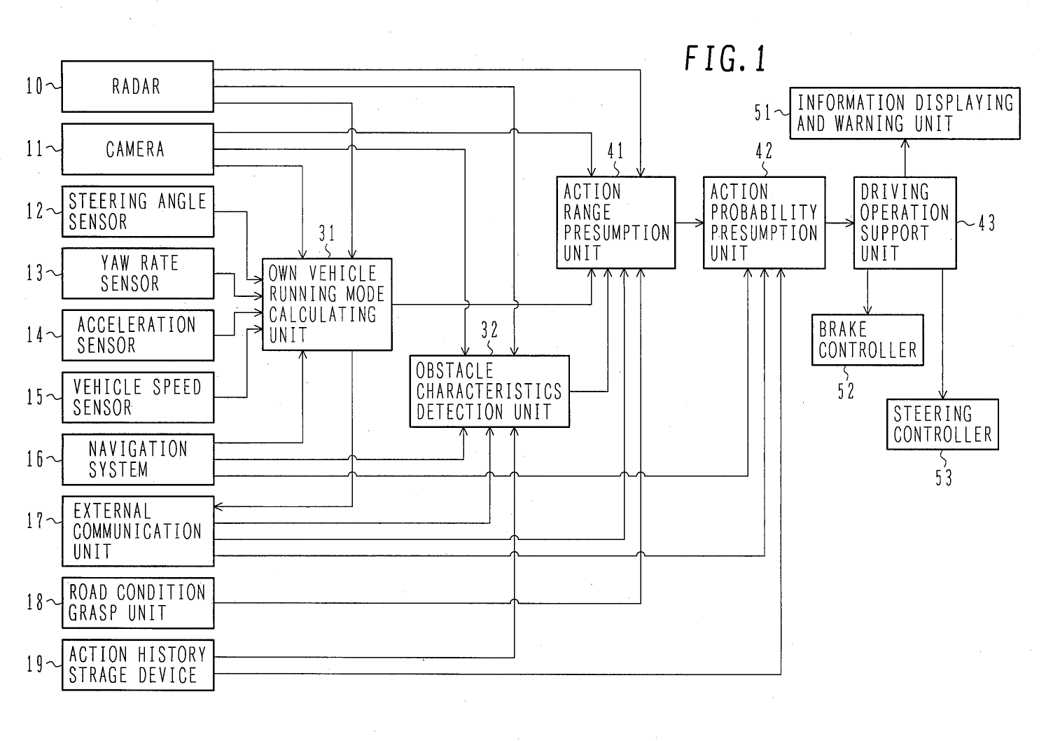

A collision avoidance system will be described with reference to the accompanying drawings. FIG. 1 shows the configuration of the collision avoidance system.

The collision avoidance system includes, as principal components, radars 10, cameras 11, a steering angle sensor 12, a yaw rate sensor 13, an acceleration sensor 14, a vehicle speed sensor 15, a navigation system 16, an external communication unit 17, a road condition grasp unit 18, an action history storage device 19, a host vehicle running mode calculating unit 31, an obstacle characteristics detection unit 32, an action range presumption unit 41, an action probability presumption unit 42, a driving operation support unit 43, an information displaying and warning unit 51, a brake controller 52, and a steering controller 53.

The radars 10 and the cameras 11 are obstacle detection means capable of detecting obstacles around a host vehicle. The radar 10 is a laser radar or a millimeter-wave radar. The radars 10 are disposed, for example, on a front part, the rear bumper, the front side of the rearview mirror, an upper part of the rear window, and the sideview mirrors, respectively, of the host vehicle. The radars 10 have detection ranges extending forward, rearward and sideward in predetermined angular ranges from the radars 10, respectively. The radars 10 detect obstacles existing around the host vehicle. Each of the radars 10 calculates the position, acceleration and yaw rate of an obstacle on the basis of information obtained through detection, and gives the calculated data to the running mode calculating unit 31, the obstacle characteristics detection unit 32 and the action range presumption unit 41.

The cameras 11 are CCD cameras or CMOS cameras. The cameras 11 are disposed, for example, on a front part, the rear bumper, the front side of the rearview mirror, an upper part of the rear window and the sideview mirrors, respectively, of the host vehicle. The cameras 11 have large angular fields extending forward, rearward and sideward in predetermined angular ranges from the cameras 11, respectively. The cameras 11 photograph obstacles existing on the road on which the host vehicle is running or around the host vehicle and process the images of the obstacles by applying image processing such as edge detection and feature extraction, i.e., a process for extracting white lines and patterns of automobiles from the edge information obtained. Thus, the images of the license plates and such of the obstacles are removed from the images. The cameras 11 also extract white and yellow lane marks marked on the surface of the road and output the obtained information about the license plates and such of the obstacle to the running mode calculating unit 31, the obstacle characteristics detection unit 32 and the action range presumption unit 41.

The steering angle sensor 12 measures the steering angle of the wheel of the host vehicle and outputs a signal representing the measured steering angle to the running mode calculating unit 31. The yaw rate sensor 13 provides a signal representing an angular speed at which the host vehicle is rotating about a vertical axis passing the center of gravity of the host vehicle to the running mode calculating unit 31. The acceleration sensor 14 measures a longitudinal acceleration and a transverse acceleration acting on the host vehicle and outputs the signal representing the longitudinal and the transverse acceleration to the running mode calculating unit 31. The vehicle speed sensor 15 gives a pulse signal representing the running speed of the host vehicle to the running mode calculating unit 42.

The navigation system 16 outputs map information about branching and merging of traffic lanes and information about traffic accident occurrence rate and traffic congestion to the running mode calculating unit 31, to the obstacle characteristics detection unit 32 and also to the action probability presumption unit 42 in FIG. 1.

The external communication unit 17 communicates with roadside base stations and sensors or beacons installed on the road by radio. The external communication unit 17 also communicates with the other external communication units 17 installed on other vehicles to obtain the information about actions of obstacles such as acceleration and deceleration acting on the other vehicles, turning motions of the other vehicles and destinations of the other vehicles and outputs signals representing the acquired information to the obstacle characteristics detection unit 32, the action range presumption unit 41 and the action probability presumption unit 42. The external communication unit 17 also sends out signals representing information about the behavior of the host vehicle received from the running mode calculating unit 31.

If the road is icy, the coefficient of friction on the road is small, and braking distance is long; the vehicle skids and turning radius increases when a steering operation is made. Also, braking distance is long if the road slopes down. Thus, the respective action ranges of the host vehicle and the obstacle are dependent on the coefficient of friction on the road and the inclination of the road. The road condition grasp unit 18 determines the coefficient of friction on the road on which the host vehicle and the obstacle exist and the inclination of the same road. The road parameter determining unit 18 determines coefficient of friction on the road on the basis of the difference in speed between the front wheel, namely, a driving wheel, and the rear wheel and the acceleration acting on the vehicle body. The road condition grasp unit 18 measures the inclination of the road by an inclination sensor and outputs a signal representing the values of those parameters to the action range presumption unit 41. The coefficient of friction may be presumed from changes in the speed of the wheels when the brake is applied.

Drivers change traffic lanes at different frequencies and decelerate the vehicle in different braking modes. Upon the detection of an obstacle by the radar 10, the camera 11, and the external communication unit 17 and the identification of the obstacle by the license plate and such of the obstacle, the action history storage device 19 stores data on the behavior of the obstacle and the behavior of the host vehicle after the detection of the obstacle and outputs a signal representing the data on the behavior of the obstacle and the host vehicle to the obstacle characteristics detection unit 32 and the action probability presumption unit 42.

The running mode calculating unit 31 calculates data on the behavior of the host vehicle and the running mode of the host vehicle such as positions of the host vehicle in relation to the driving road with reference to white and yellow lane marks marked on the surface of the road on the basis of information provided by the radars 10, the cameras 11, the steering angle sensor 12, the yaw rate sensor 13, the acceleration measuring device 14, the vehicle speed sensor 15 and the navigation system 16, and outputs the signals representing those data to the external communication unit 17 and the action range presumption unit 41.

The obstacle characteristics detection unit 32 identifies the types of the obstacle such as a large vehicle such as a truck, an ordinary automobile, a motorcycle or a stationary object on the basis of the information provided by the radars 10, the cameras 11, the navigation system 16, the external communication unit 17 and the action history storage device 19; then, the obstacle characteristics detection unit 32 outputs a signal representing the moving performance of the obstacle thus identified to the action presumption unit 41.

The action range presumption unit 41 presumes the ranges in which the host vehicle and the obstacle can exist, respectively, in a predetermined time (hereinafter referred to as “action ranges”) on the basis of the information provided by the radars 10, the cameras 11, the external communication unit 17, the road condition grasp unit 18, the running mode calculating unit 31 and the obstacle characteristics detection unit 32, and outputs the information about the presumed action ranges to the action probability presumption unit 42. The action range presumption unit 41 determines those action ranges by successively connecting the presumed positions at which the host vehicle and the obstacle can exist, respectively, when, for example, the host vehicle and the obstacle accelerate or decelerate at the maximum rate or turn. When there is a stationary obstacle ahead of a moving obstacle and the moving obstacle cannot avoid colliding with the stationary obstacle, the action range presumption unit 41 presumes a position at which the moving obstacle is to exist if the moving obstacle is decelerated at the maximum deceleration to be a position where the moving obstacle is to exist when the moving obstacle collides with the stationary obstacle.

The action probability presumption unit 42 presumes the probabilities of the host vehicle and the obstacle existing at each position in the action ranges (hereinafter referred to as “action probabilities”) on the basis of the information provided by the action range presumption unit 41, the navigation system 16, the external communication unit 17 and the action history storage device 19 and outputs the signals representing the action probabilities to the driving operation support unit 43. The action probability presumption unit 42 may determine the region connecting the positions of the same action probability and output the signals representing the regionalized information to the driving operation support unit 43.

The driving operation support unit 43 determines a target locus which allows the host vehicle to avoid entering the action range of the obstacle presumed by the action range presumption unit 41 and generates driving support data on the basis of the information provided by the action probability presumption unit 42; then, the driving operation support unit 43 outputs commands to the information displaying and warning unit 51, the brake controller 52 and the steering controller 53. If the host vehicle has no choice but to enter the action range of the obstacle even if the driving operation support is executed, the driving operation support unit 43 determines a target locus and generates driving operation support information necessary for leading the host vehicle to the region generated by the action probability presumption unit in which the action probability of the obstacle is low. Thus, the driving operation support unit 43 determines the target locus and generates the driving operation support information such that damage to both of the host vehicle and the obstacle is minimal if the host vehicle collides with the obstacle.

The information displaying and warning unit 51 gives the driver information on the basis of the commands provided by the driving operation support unit 43. The information displaying and warning unit 51 displays the information about the target locus enabling the collision avoidance between the host vehicle and the obstacle, the positional relation between the host vehicle and the obstacle, and the action ranges and probability ranges of the obstacle to, for example, the display of the navigation system 16 or uses the speaker of audio equipment to give an audio warning to the driver. The levels of the visual information displayed by the display of the navigation system 16 and those of the audio information provided by the speaker of the audio equipment about the positional relation between the host vehicle and the obstacle, the probability of collision and such may be indicated by different colors and different sound volumes, respectively.

The brake controller 52 assists the driver with a braking operation, namely, a vehicle control operation, according to the command given thereto by the driving operation support unit 43. The brake controller 52 controls the brake fluid pressures applied to the brake calipers (not shown in the figures), each of which is installed on each wheel, so that the vehicle may run along the target locus and can be prevented from becoming uncontrollable due to spin or the like.

The steering controller 53 assists the driver with a steering operation, namely, a vehicle control operation according to the command given thereto by the driving operation support unit 43. The steering controller 53 controls the hydraulic or electric power transmission mechanism for amplifying the driver's steering force to obtain a high steering force and transmitting the high steering force to the steering wheels of the vehicle so that the vehicle may run along the target locus and can be prevented from becoming uncontrollable due to spin or the like. The steering controller 53 may operate simultaneously with the information displaying and warning unit 51 and the brake controller 52.

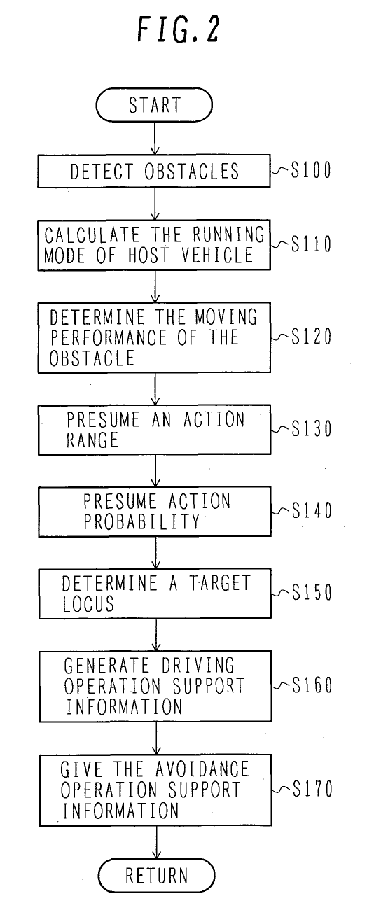

FIG. 2 is an example of a flow chart of a control procedure to be carried out by the collision avoidance system. In step S100, an obstacle existing around the host vehicle is detected by the radar 10 and the camera 11. Information about the detected obstacle is then output to the running mode calculating unit 31, the obstacle characteristics detection unit 32 and the action range presumption unit 41. The radar 10 extracts the overall width, overall height and vehicle speed of the obstacle, and the distance between the host vehicle and the obstacle from the obtained information. The camera 11 extracts the overall width, overall height and license plate of the obstacle, and white and yellow lane marks marked on the road from the photographed image. In step S110, the running mode calculating unit 31 processes the information provided by the radar 10, the camera 11, the steering angle sensor 12, the yaw rate sensor 13, the acceleration sensor 14, the vehicle speed sensor 15 and the navigation system 16 to determine running parameters including the behavior of the host vehicle and the position of the host vehicle on the road by calculation.

In step S120, the obstacle characteristics detection unit 32 identifies the types of the obstacle such as a large vehicle, ordinary automobile, motorcycle or stationary object and determines the moving performance of the identified obstacle. Step S120 may be executed before step S110.

In step S130, the action range presumption unit 41 presumes action ranges by successively connecting positions at which the host vehicle and the obstacle can exist when the host vehicle and the obstacle accelerate or decelerate at the maximum rate or turn on the basis of the information provided by the radar 10, the camera 11, the external communication unit 17, the road condition grasp unit 18, the running mode calculating unit 31 and the obstacle characteristics detection unit 32. In step S140, the action probability presumption unit 42 presumes the action probabilities of the host vehicle and the obstacle respectively acting in the action ranges on the basis of the information provided by the action range presumption unit 41, the navigation system 16, the external communication unit 17, and the action history storage device 19.

In step S150, the driving operation support unit 43 generates a target locus that prevents the host vehicle from colliding with the obstacle on the basis of the information provided by the action probability presumption unit 42. In step S160, the driving operation support unit 43 generates the driving operation support information necessary for making the host vehicle run along the target locus generated in step S150. In step S170, the driving operation support information generated by the driving operation support unit 43 is output to the information displaying and warning unit 51, the brake controller 52 and the steering controller 53. The information displaying and warning unit 51 informs the driver of collision avoidance information including the target locus. The brake controller 52 assists the driver with the braking operation and the steering controller 53 assists the driver with the steering operation to support the collision avoidance.

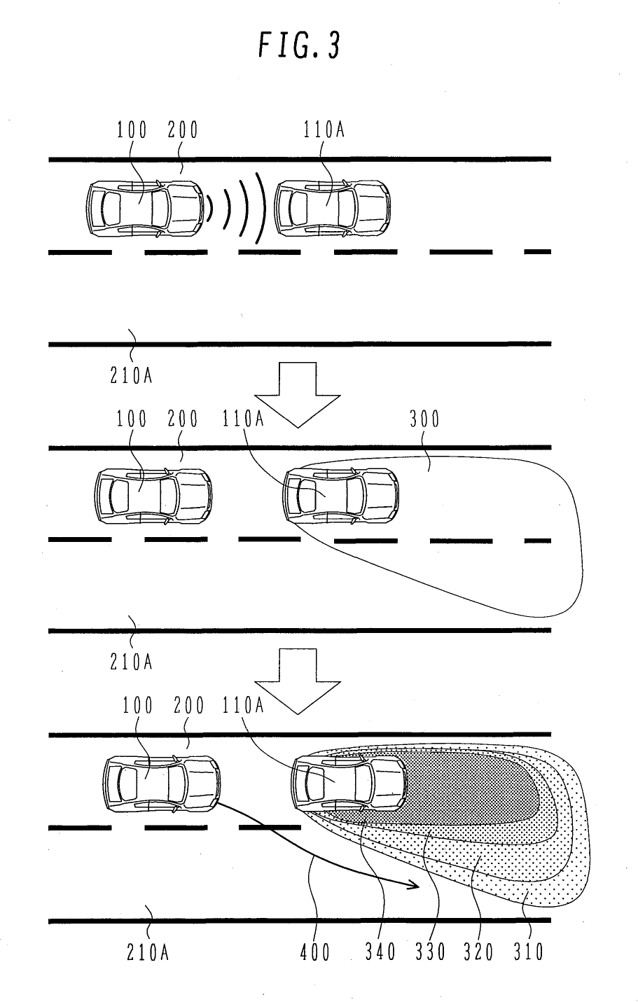

FIG. 3 is a pictorial view of assistance in explaining the control operations to be carried out by the collision avoidance system from the detection of an obstacle to the start of the driving operation support operations. A host vehicle 100 running in a traffic lane 200 detects an obstacle 110A running ahead of the host vehicle 100 in the traffic lane 200 by the radar 10 and the camera 11. The action range presumption unit 41 of the host vehicle 100 presumes an action range 300 in which the obstacle 110A will run. The action probability presumption unit 42 presumes the action probabilities of the obstacle 110A running at positions in the action range 300, and generates probability regions 310, 320, 330 and 340 by successively connecting the positions of the same probabilities. FIG. 3 shows a case where the obstacle 110A is highly likely to run at a fixed speed in the traffic lane 200, which is provided from the external communication unit 17 and the action history storage device 19. The probability region 340 is a region in which the obstacle 110A can exist at the highest probability in the action range 300. The driving operation support unit 43 of the host vehicle 100 generates a target locus 400 shown in FIG. 3 and the driving support information necessary for making the host vehicle 100 run on the target locus 400 to avoid the collision of the host vehicle 100 with the obstacle 110A when the vehicle speed of the host vehicle 100 is higher than that of the obstacle 110A. Then, the driving operation support unit 43 outputs commands to the information displaying and warning unit 51, the brake controller 52 and the steering controller 53. The information displaying and warning unit 51 gives the driver information based on the commands from the driving operation support unit 43, and the brake controller 52 and the steering controller 53 carry out driving support operations according to the commands to make the host vehicle run along the target locus 400. The collision avoidance system can provide highly reliable driving support to avoid collision by presuming an action range and a probability region for the host vehicle 100, estimating an action probability of the host vehicle 100, generating a target locus not passing the action range of the obstacle and driving support information.

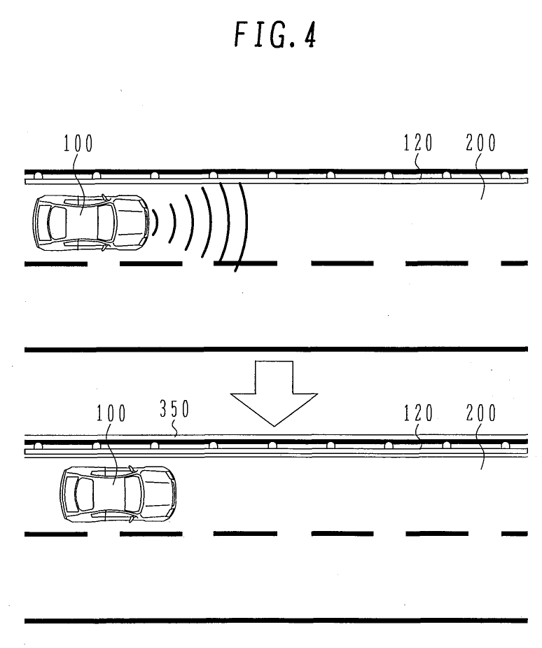

FIG. 4 is a pictorial view of assistance in explaining an action range presuming procedure to be carried out when the collision avoidance system detects a stationary obstacle lying in the vicinity of the host vehicle 100. Suppose that a guardrail 120 is installed along a traffic lane 200 on which the host vehicle is running. The action range presumption unit 41 decides that the guardrail 120 is a stationary object that cannot be easily moved on the basis of the information provided by the obstacle characteristics detection unit 32. The action range presumption unit 41 presumes an action range 350 for the guardrail 120 to be at least greater than the actual size of the guardrail 120. The size of the action range 350 presumed by the action range presumption unit 41 is increased with the increase in the vehicle speed of the host vehicle 100 so that the driver may not be terrified by driving support. An obstacle is decided to be a stationary object that cannot be easily moved on the basis of the information provided by the navigation system 16 and the information obtained through inter-vehicle communication and vehicle-roadside communication by the external communication unit 17. Thus, easily movable obstacles such as vehicles and not easily movable obstacles such as guardrails can be distinguished from each other; the time required by the action probability presumption unit 42 for calculation can be shortened, and also the latitude to generate a target locus for collision avoidance and its accuracy can be improved.

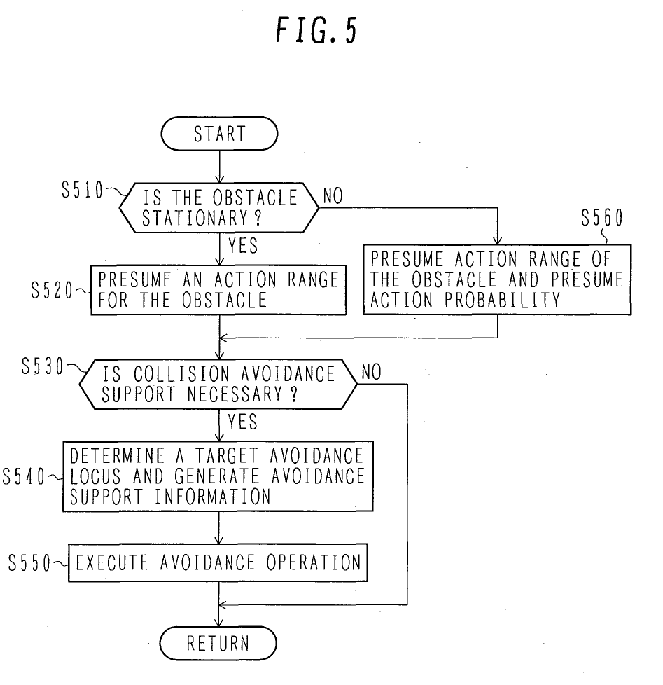

FIG. 5 is a flow chart of an example of a control procedure to be carried out by the collision avoidance system when the collision avoidance system detects a stationary obstacle around the host vehicle as shown in FIG. 4.

In step 510, a query is made to see whether or not an obstacle is stationary. If the obstacle is stationary, the procedure proceeds to step S520 in which an action range for the obstacle is presumed. If the obstacle is moving, the procedure proceeds to step S560 in which an action range for the obstacle is presumed by the action range presumption unit 41, and an action probability of the obstacle existing in the action range is presumed by the action probability presumption unit 42. In step S530, a query is made to see whether or not driving support is necessary for collision avoidance. If driving support is necessary for collision avoidance, the driving operation support unit 43 generates a target locus and driving operation support information for collision avoidance in step S540; then, the procedure proceeds to step S550 to assist the driver with a braking operation and a steering operation.

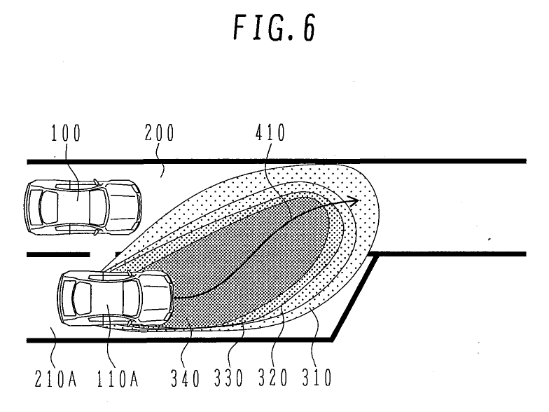

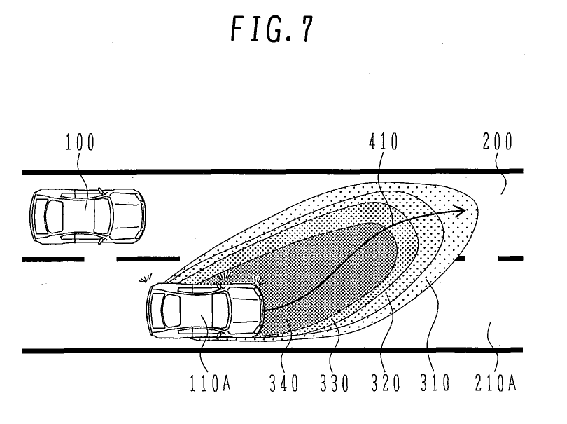

FIGS. 6 and 7 are pictorial views of assistance in explaining operations for estimating an action probability and presuming an action range when an obstacle enters the lane a host vehicle is running from ahead of the host vehicle and the collision avoidance system detects the obstacle. For example, when a traffic lane 210A which is adjacent to and runs in the same direction as a traffic lane 200 on which the host vehicle 100 is running narrows ahead as shown in FIG. 6, or when an obstacle 110A running in the traffic lane 210A turns on a turn-signal lamp toward the traffic lane 200 on which the host vehicle 100 is running as shown in FIG. 7, the action probability presumption unit 42 presumes that the obstacle 110A running in the traffic lane 210A moves along a locus 410 into the traffic lane 200 on which the host vehicle 100 is running and presumes probability regions 310 to 340 of action probabilities of the obstacle 110A moving in the probability regions 310 to 340. Those action probabilities are set to be higher than those when the obstacle 110A does not need to change traffic lanes.

The driving operation support unit 43 gives the information displaying and warning unit 51 the information to notify the driver of the present situation and to prompt the driver to carry out a braking operation based on the presumed result, and assists the driver with a braking operation by outputting an automatic deceleration command to the brake controller 52. Consequently, the collision of the host vehicle 100 with the obstacle 110A can be avoided when the obstacle 110A cuts into the traffic lane 200 from ahead of the host vehicle 100.

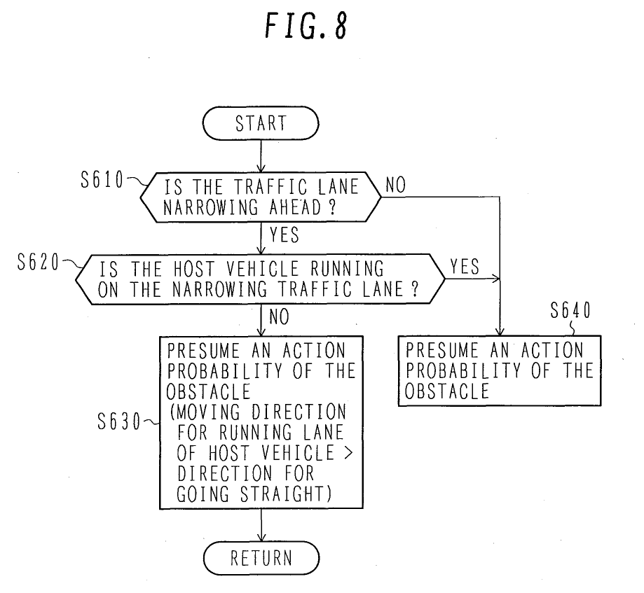

FIG. 8 is a flow chart of an example of a control procedure to be carried out by the collision avoidance system when an obstacle cuts into the traffic lane on which a host vehicle is running from ahead of the host vehicle as shown in FIG. 6.

In step S610, a query is made to see whether or not the traffic lane narrows ahead. If the response to the query made is affirmative, the procedure proceeds to step S620 in which another query is made to see whether or not the host vehicle is running on the narrowing traffic lane. If the response to the query made in step S620 is negative, the procedure proceeds to step S630 in which an action range for the obstacle is presumed, and an action probability of the obstacle acting in the action range is presumed on the assumption that a probability of the obstacle moving to a position in front of the host vehicle is high. Then, driving operation support operations are carried out on the basis of the presumed action range and the presumed action probability. If the response to the query made in step S620 is affirmative, the procedure proceeds to step S640 in which an action range for the obstacle is presumed, and an action probability of the obstacle acting in the action range is presumed. Driving operation support operations are carried out on the basis of the action range and the action probability.

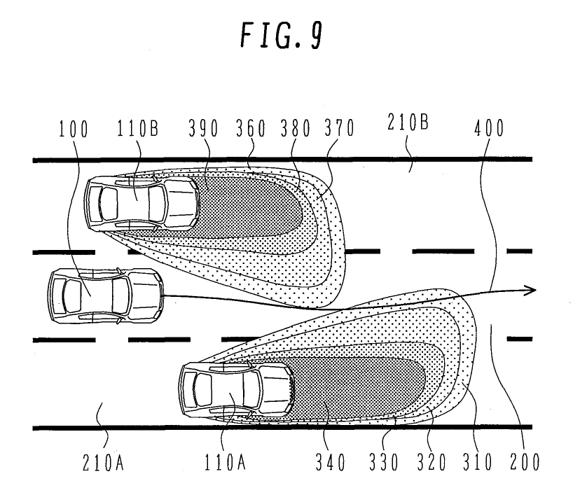

FIG. 9 is a pictorial view of assistance in explaining a control procedure to be carried out by the collision avoidance system when a host vehicle has no choice but to enter the action ranges of obstacles on the right and the left side of the host vehicle. For example, when the host vehicle 100 is running on a traffic lane 200 as shown in FIG. 9, the action range presumption unit 41 presumes action ranges for each of obstacles 110A and 110B running in traffic lanes 210A and 210B, respectively. The action probability presumption unit 42 presumes action probabilities 310 to 340 of the obstacle 110A running in its action ranges and presumes action probabilities 360 to 390 of the obstacle 110B running in its action ranges. A space ahead of the host vehicle 100 is occupied by the action ranges of the obstacles 110A and 110B. If the driver of the host vehicle 100 intends to overtake the obstacles 110A and 110B under such a condition, the driving operation support unit 43 determines the probability regions the obstacles are least likely to enter to generate the shortest possible target locus 400 and driving operation support information. The driving operation support unit 43 takes the moving ability of the host vehicle 100 into consideration in generating the target locus 400 and the driving operation support information.

In the collision avoidance system in the preferred embodiment of the present invention, the driving operation support unit 43 determines a mode of assisting the driver of the host vehicle with driving operations on the basis of the information provided by the action range presumption unit 41 and the action probability presumption unit 42 to avoid the collision of the host vehicle with the obstacle.

Although the preferred embodiment of the present invention has been described in detail, the components of the collision avoidance system are not limited to those specifically described herein and may be changed unless the functions featured by the present invention are not spoiled.

What is claimed is:

1. A collision avoidance system comprising:
an obstacle detection means for detecting obstacles existing in the vicinity of a host vehicle;
an action range presumption means for presuming an action range in which an obstacle can exist at time a predetermined time after being detected on the basis of the moving performance of the obstacle detected by the obstacle detection means;
an action probability presumption means for estimating an action probability of the obstacle existing in the action range presumed by the action range presumption means; and
a driving operation support means for determining driving operation support operations on the basis of the action range presumed by the action range presumption means and the action probability presumed by the action probability presumption means and executing the driving operation support operations.

2. The collision avoidance system according to claim 1, wherein the action range presumption means further presumes an action range in which the host vehicle can exist in a predetermined time, and the action probability presumption means further presumes an action probability of the host vehicle existing in the action range.

3. The collision avoidance system according to claim 1 further comprising an obstacle characteristics detection means for identifying the type of the obstacle;
wherein the action range presumption means presumes the action range and the action probability presumption means presumes the action probability on the basis of the moving performance specific to the type of the obstacle identified by the obstacle characteristics detection means.

4. The collision avoidance system according to claim 1 further comprising a road condition grasp means for determining the condition of a road on which at least either of the host vehicle and the obstacle is running;
wherein the action range presumption means changes the action range presumed according to the road condition determined by the road condition grasp means, and the action probability presumption means changes the action probability presumed according to the road condition determined by the road condition grasp means.

5. The collision avoidance system according to claim 1 further comprising an action history storage means for storing an action history of the obstacle;
wherein the action probability presumption means presumes the action probability of the obstacle existing in the action range presumed by the action range presumption means taking into consideration the action history stored in the action history storage means.

6. The collision avoidance system according to claim 1 further comprising an external communication means capable of communicating with an external system;
wherein the action range presumption means presumes a range in which the obstacle can exist taking into consideration the information about the actions of the obstacle acquired through the external communication means, and the action probability presumption means presumes an action probability of the obstacle existing in the action range.

7. The collision avoidance system according to claim 1, wherein, when the obstacle changes traffic lanes, the action probability presumption means presumes a higher probability of the obstacle moving in the direction in which the traffic lane is changed as compared with a probability of the obstacle existing in the action range when the obstacle does not need to change traffic lanes.

8. The collision avoidance system according to claim 1, wherein, when the obstacle is stationary and cannot easily move, the action range presumption means presumes a range in which the obstacle can exist to be greater than the size of the obstacle.

9. The collision avoidance system according to claim 1, wherein the action range presumption means increases the presumed range in which the obstacle can exist as the running speed of the vehicle increases.

10. The collision avoidance system according to claim 1, wherein, when a turn-signal lamp of the obstacle is turned on, the action probability presumption means presumes a higher probability of the obstacle moving in the direction indicated by the turn-signal lamp as compared with a probability of a case where any turn-signal lamp is not turned on.

11. The collision avoidance system according to claim 1, wherein the driving operation support means executes driving operation support operations so as to avoid the host vehicle moving into the action range presumed by the action range presumption means.

12. The collision avoidance system according to claim 1, wherein, when the vehicle unavoidably moves into an action range presumed by the action range presumption means in which the obstacle is expected to exist in a predetermined time, the driving operation support means carries out driving operation support operations so that the vehicle moves in a direction in which a probability presumed by the action probability presumption means is low.

13. An automobile on which the collision avoidance system according to claim 1 is mounted.
